(19) United States
(12) Patent Application Publication
(10) Pub. No.: US 2021/0109607 A1
(43) Pub. Date: Apr. 15, 2021

(54) SYSTEMS AND METHODS FOR PREDICTION OF USER AFFECT WITHIN SAAS APPLICATIONS

(71) Applicant: Elsevier, Inc., New York, NY (US)

(72) Inventors: Steven Stalzer, Holliston, MA (US); Paul D. Crockett, Jamaica Plain, MA (US); Gabriel Gabra Zaccak, Cambridge, MA (US)

(73) Assignee: Elsevier, Inc., New York, NY (US)

(21) Appl. No.: 17/070,595

(22) Filed: Oct. 14, 2020

Related U.S. Application Data
(60) Provisional application No. 62/915,578, filed on Oct. 15, 2019.

(51) Int. Cl. G06F 3/03; G06K 9/62; G06F 3/01; G06N 20/00

(52) U.S. Cl. CPC G06F 3/0317; G06K 9/6232; G06F 2203/011; G06F 3/011; G06N 20/00; G06K 9/6256

(57) ABSTRACT

A method of generating a user affect prediction includes receiving a label for a user-reported affect corresponding to interactions with the user interface, receiving events corresponding to the interactions with the user interface, identifying one or more patterns of the events as one or more gestures and extracting one or more features of the gestures. The method uses a machine learning model to generate a user affect prediction based on the training features. The user affect prediction represents a predicted user affect corresponding to the interactions with the user interface. The machine learning model may be trained by modifying one or more parameters of the machine learning model using a difference between the label and the generated user affect prediction.

### CROSS-REFERENCE TO RELATED PATENT APPLICATION

This application is a non-provisional utility application claiming priority to U.S. Provisional Application No. 62/915,578, titled “Systems and Methods for Prediction of User Affect Within SAAS,” filed on Oct. 15, 2019, the entirety of which is incorporated herein by reference.

### TECHNICAL FIELD

The present application is generally directed to systems and methods for providing a platform for predicting user affect, such as frustration, engagement, and confidence, while interacting with a user interface, such as online content within a software as a service (SaaS) computer program.

### BACKGROUND

A portion of the disclosure of this patent document contains material which is subject to copyright protection. The copyright owner has no objection to the facsimile reproduction by anyone of the patent document or the patent disclosure, as it appears in the file or records of the Patent and Trademark Office, but otherwise reserves all copyright rights whatsoever.

It is often useful to determine a customer's mood or affect that results from an interaction. Although in person, it may appear trivial to guess how a customer feels about his or her service, determining user affect in online interactions is more difficult. Company's often obtain customer affect information by asking customers how they feel through a survey presented after the online interaction. However, these surveys are typically optional and, therefore, can only provide insight on the specific users who choose to participate. Optional surveys can also bias aggregate results by selecting a sample primarily from among users at the extremes of dissatisfied, satisfied, or bored.

Therefore, a need exists for predicting user affect based on user interactions with a user interface such as online content within a software as a service (SaaS) computer program.

### SUMMARY

The commercial realm typically focuses on identifying specific user actions while interacting with webpages, such as multiple rapid clicks on a broken hyperlink (so-called “rage clicking”) and inferring the user's mental state from those actions. These applications typically focus on identifying usability issues within web content, are content-specific, and do not generalize well to other types of online content.

Academic institutions typically focus on small studies in which user mouse movements can be used to infer affect, primarily through statistical and machine learning methods. These methods are not easy to generalize outside of the setting and content of the studies, which tend to be constrained to very specific activities.

According to an embodiment, a method of generating a user affect prediction includes receiving one or more events generated from a user interface, identifying a pattern, among the received events, as a gesture, extracting one or more features of the gesture, and generating a user affect prediction, based on the extracted features, using a trained machine learning model.

According to another embodiment, the method further includes training a machine learning model to generate the user affect prediction based on the one or more events generated from the user interface.

According to yet another embodiment, the training of the machine learning model includes receiving a label for a user-reported affect corresponding to interactions with the user interface, receiving, as training events, events corresponding to the interactions with the user interface, identifying one or more patterns, among the training events, as one or more training gestures, extracting, as one or more training features, one or more features of the training gestures, providing the training features and the label to a machine learning model, and using the machine learning model to generate a training prediction based on the training features. The generated training prediction represents a predicted user affect corresponding to the interactions with the user interface. The method may further include generating the trained machine learning model by modifying one or more parameters of the machine learning model using a difference between the label and the training prediction.

According to yet another embodiment, the one or more gestures include a decision gesture including events collected between a decision point, including a change in direction, and a submit click.

According to yet another embodiment, the extracting of one or more features includes performing one or more calculations of one or more feature definitions corresponding to the one or more features.

According to yet another embodiment, the one or more features include an inception feature, a number of clicks feature, an acceleration feature, an acceleration fast Fourier transform feature, and an earth mover's distance feature.

According to yet another embodiment, the events include one or more of a mouse movement, a mouse click, or a keypress.

Embodiments of the present disclosure improve prediction of user affect by providing an end to end solution, which can generalize easily to a wide variety of online content. Specifically, the systems and methods in this disclosure can predict a user's frustration, engagement, and confidence on any webpage which contains a set of actions or tasks, followed by clicking a “submit” or similar button to conclude the task.

One or more embodiments of the present disclosure includes a data generation algorithm within the web client which converts a user's mouse movements to discrete events that capture every pixel traversed in the web page, as well as every other interaction, such as clicking on a button or typing.

Another embodiment of the present disclosure includes a data ingestion pipeline which receives the user data sent by the client in real time, can scale to billions of events, and stores the normalized data in a data warehouse that can be queried.

Yet another embodiment of the present disclosure includes an event processing system that is able to extract target gestures (a sequence of mouse events) from the raw data stream.

Yet another embodiment of the present disclosure includes a machine learning pipeline, which extracts features from the target gestures for training of machine learning models and for executing predictions.

Yet another embodiment of the present disclosure includes a procedure for outputting predictions as annotations which contain a probability and prediction of the user's affect level.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A illustrates a block diagram depicting an embodiment of a network environment comprising a client device in communication with server device, according to one or more disclosed embodiments;

FIG. 1B illustrates a block diagram depicting a cloud computing environment comprising a client device in communication with cloud service providers, according to one or more disclosed embodiments;

FIGS. 1C and 1D illustrate block diagrams depicting embodiments of computing devices useful in connection with the methods and systems described herein, according to one or more disclosed embodiments;

FIG. 1E illustrates a block diagram that depicts the components of an overall system for predicting user affect, according to one or more disclosed embodiments;

FIG. 2A illustrates a flow chart of a method of the event collector which collects events from a user interface, according to one or more disclosed embodiments;

FIG. 2B illustrates a non-limiting example of events collected by the event collector, according to one or more disclosed embodiments;

FIG. 3 illustrates the Data Ingestion pipeline for receiving and processing client events, according to one or more disclosed embodiments;

FIG. 4 illustrates a non-limiting example of a gesture or decision gesture, which represent a target segment extracted from the full trajectories of all mouse movements on a page, according to one or more disclosed embodiments;

FIG. 5 illustrates a flow chart of the Gesture Extractor, which outputs the pattern of events for one or more gesture types, and stores the gesture to a database, according to one or more disclosed embodiments;

FIG. 6 illustrates a first set of machine learning (ML) features extracted from a target gesture, and used to train an affect prediction model, according to one or more disclosed embodiments;

FIG. 7 illustrates a second set of machine learning (ML) features extracted from a target gesture, and used to train an affect prediction model, according to one or more disclosed embodiments;

FIG. 8 illustrates a machine learning model training process of a machine learning pipeline, according to one or more disclosed embodiments;

FIG. 9 illustrates the machine learning predictor or annotator of a machine learning pipeline, according to one or more disclosed embodiments;

FIG. 10A illustrates a sample frustration report showing the affect predictions for a user across all webpages on a website, according to one or more disclosed embodiments (in this non-limiting example the website is an online assessment); and

FIG. 10B illustrates a sample engagement report showing the affect predictions for a user across all webpages on a website all webpages on a website, according to one or more disclosed embodiments (in this non-limiting example the website is an online assessment).

### DETAILED DESCRIPTION

The commercial realm typically focuses on identifying specific user actions while interacting with webpages, such as multiple rapid clicks on a broken hyperlink (so-called “rage clicking”) and inferring the user's mental state from those actions. These applications typically focus on identifying usability issues within web content, are content-specific, and do not generalize well to other types of online content.

Academic institutions typically focus on small studies in which user mouse movements can be used to infer affect, primarily through statistical and machine learning methods. These methods are not easy to generalize outside of the setting and content of the studies, which tend to be constrained to very specific activities.

For purposes of reading the description of the various embodiments below, the following descriptions of the sections of the specification and their respective contents may be helpful: Section A describes a network environment and computing environment which may be useful for practicing embodiments described herein; Section B describes embodiments of systems and methods for predicting user affect.

### A. Computing and Network Environment

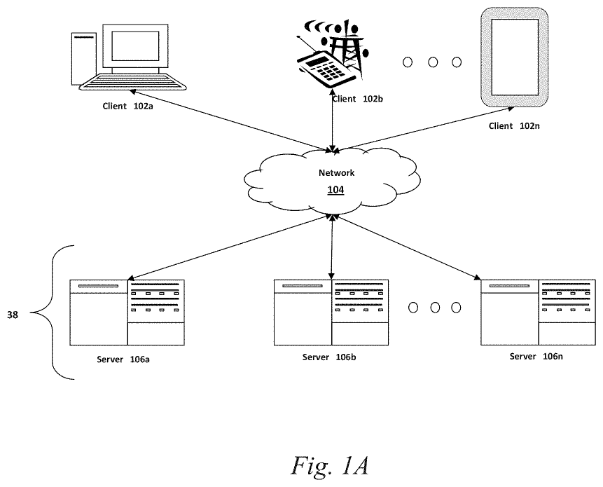

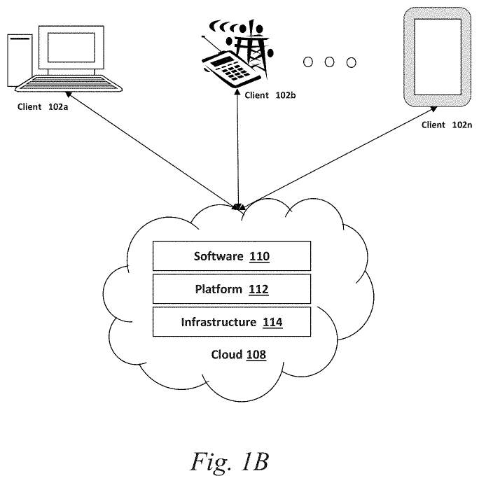

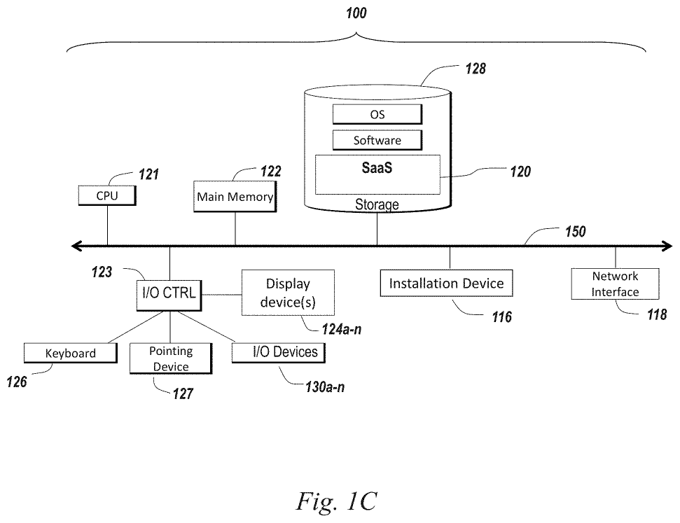

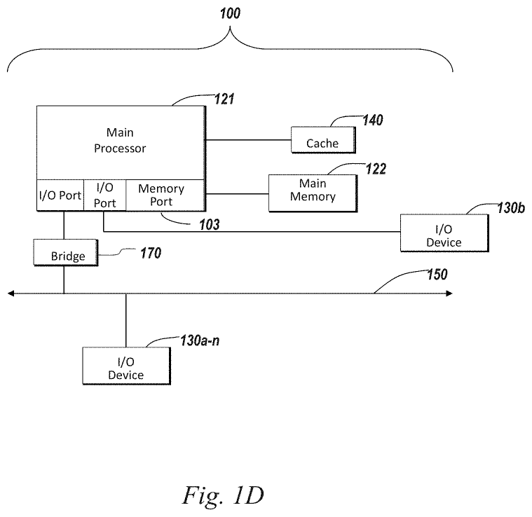

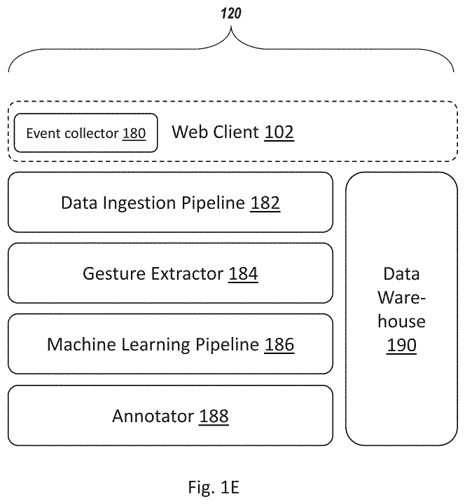

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 includes the capacity to function as both a client node seeking access to resources provided by a server and as a server providing access to hosted resources for other clients 102a-102n.

In the disclosed embodiments, the network 104 may include one or more computer networks (e.g., a personal area network, a local area network, grid computing network, wide area network, etc.), cellular networks, satellite networks, the internet, a virtual network in a cloud computing environment, and/or any combinations thereof. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB, Serial ATA, eSATA, and FireWire. Accordingly, the network 104 can be utilized as a wireless access point by the system to access one or more servers 106a, 106b, 106c.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including but not limited to standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, IS-95, CDMA-2000, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In some embodiments, the logical group of servers may be referred to as a server farm 38 or a machine farm 38. In some embodiments, the servers 106 may be geographically dispersed. In other embodiments, a machine farm 38 may be administered as a single entity. In some embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In some embodiments, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools may allow more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may include components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, software, such as software of a SaaS 120, implementing an embodiment of the present disclosure. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (B SRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAIVI), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically provides a faster response time than main memory 122 and typically includes one or more of SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may include a storage device 128 (e.g. one or more hard disk drives or redundant arrays of independent disks) for storing an operating system or other related software, and for storing application software programs such as any program related to the software 120 for the experiment tracker system. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may include a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1C and 1D may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 includes sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may include a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is a eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

B. Prediction of User Affect within SaaS Application

The present disclosure relates to systems and methods for providing a platform for predicting user affect, such as frustration, engagement, and confidence, while interacting with online content within a SaaS computer program or other software. The platform is capable of identifying users who think creatively, use evidence to support their solutions to complex problems, and communicate clearly in a variety of contexts. The platform is capable of identifying a user's performance on complex, open-ended problems. The platform is capable of putting users in real-world scenarios and learning from what they do. The platform is capable of delivering authentic problem-based assessments efficiently, at scale, and designed for integration. The platform is capable of tracking a diverse set of signals from direct and indirect inputs to observe and measure competency, and adapting to interactions in real-time. The platform is capable of analyzing user patterns and decisions against reference data ranging from novice to expert using machine learning and data analytics. The platform is capable of revealing insights and learning pathways with clear, actionable reports to inform data-driven decisions.

Referring now to FIG. 1E, FIG. 1E illustrates a block diagram that depicts the components of an overall system for predicting user affect, according to one or more disclosed embodiments. The system includes an event collector 180. The event collector 180 may be configured to operate within a web client, a browser, a mobile application, workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device, and/or the computer system 100. The event collector 180 is configured to collect events by tracking a user's interaction with a touch interface, an input device, a keyboard, and/or a pointing device. In some embodiments, the pointing device includes a computer mouse. As described herein, the event collector 180 is communicatively coupled with a data ingestion pipeline 182, a gesture extractor 184, a machine learning pipeline 186, an annotator 188, and a data warehouse 190.

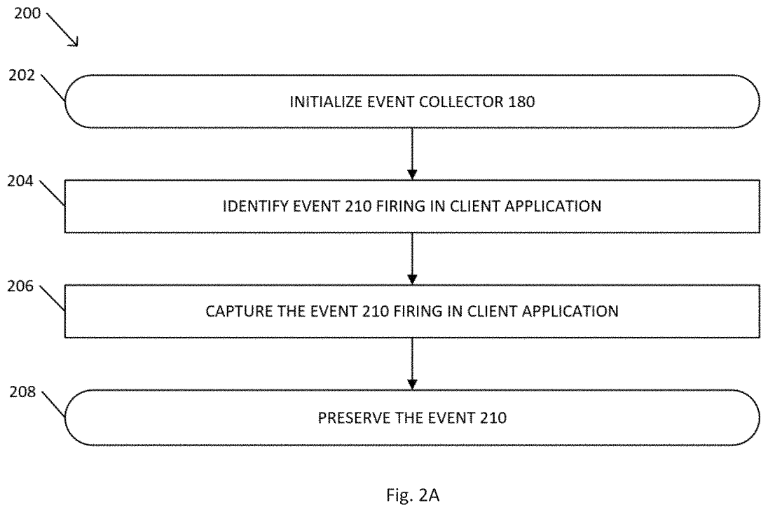

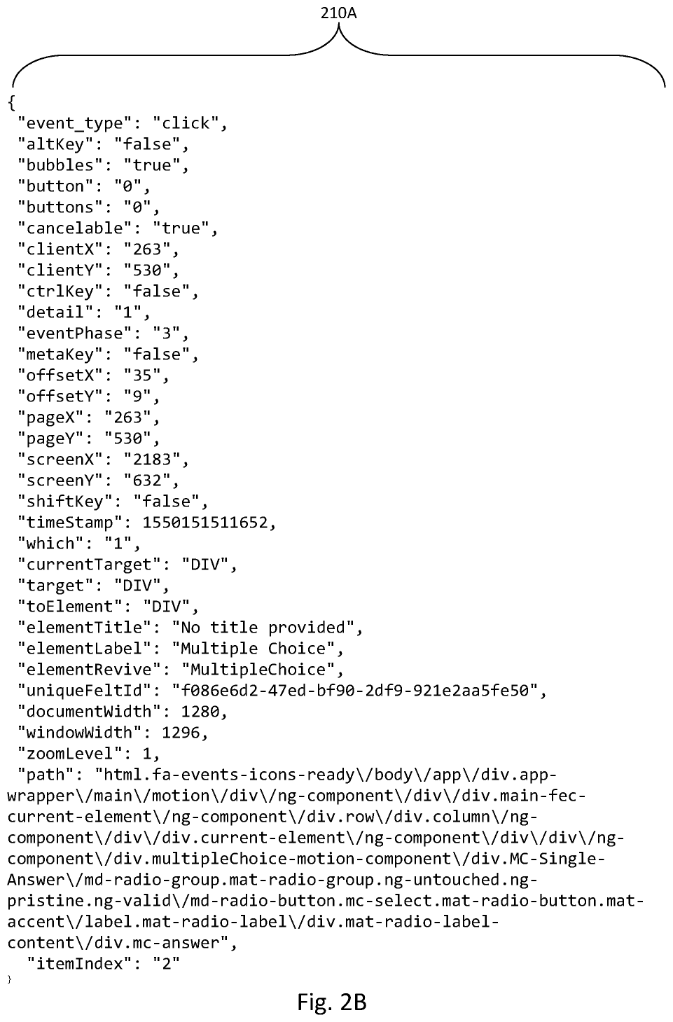

Referring now to FIG. 2A, FIG. 2A illustrates a flow chart 200 of a method of the event collector 180 which collects events 210 from a user interface, according to one or more disclosed embodiments. The event 210 includes or is associated with events 210a-210n (generally referred to using reference numeral 210). An event 210 may include an interaction with content such as: a mouse click, a mouse traversal, a click, a pause, idle time, key press, content switch, context switch, button availability, and/or network activity. In some embodiments, the event collector 180 comprises a Javascript event collector. The method 200 can include initializing the event collector 180 (BLOCK 202). The method 200 can include identifying events 210 firing in a client application (BLOCK 204). In some embodiments, the client application may include but is not limited to a browser. The method 200 can include capturing the event, including capturing context of the events, firing in the client application (BLOCK 206). In some embodiments, data representing the captured events is sent to the data ingestion pipeline 182. The method 200 can include preserving the captured events 210 (BLOCK 208). In some embodiments, the events are preserved in the data warehouse 190.

The event collector 210 may be implemented as a software layer configured to monitor user inputs on one or more IO ports. Events 210 detected may be recorded in one or more event logs 300. The event collector 210 may include an event logger. According to some embodiments, the event collector 210 may include any software, hardware, or combination thereof configured to record, save, encode, log, or otherwise preserve events 210. One of ordinary skill in the art will understand there are a variety of known methods to log and collect events without departing from the spirit and scope of the disclosed embodiments.

Referring now to FIG. 2B, FIG. 2B is an example of an event 210A comprising event elements as collected by the event collector 180. The events may be collected via layers. A layer can be acquired from an application, an application programming interface (API), or a computing library. The layers may be implemented as JavaScript layers. Any type and form of available data for an event may be collected. For example, the event elements may include: an event type, “event type”; the status of any of the alt keys, “altKey”; whether the event can propagate the document object hierarchy, “bubbles”; which mouse button is pressed, “button”; which mouse buttons are pressed, “buttons”; whether the event is cancelable, “cancelable”; the x-coordinate of the mouse pointer relative to the top-left corner of the browser, “clientX”; the y-coordinate of the mouse pointer relative to the top-left corner of the browser, “clientY”; the status of any of the ctrl keys when the event occurred, “ctrlKey”; additional information about the event, “detail”; the processing phase of the event, “eventPhase”; the status of the meta key when the event occurred, “metaKey”, the x-coordinate of the mouse pointer relative to the top left corner of a parent element, “offsetX”; the y-coordinate of the mouse pointer relative to the top left corner of a parent element “offsetY”, the x-coordinate of the mouse pointer relative to the top left corner the document, “pageX”; the y-coordinate of the mouse pointer relative to the top left corner the document, “pageY”, the x-coordinate of the mouse pointer relative to the top left corner the screen, “screenX”; the y-coordinate of the mouse pointer relative to the top left corner the screen, “screenY”; the status of any of the shift keys when the event occurred, “shiftKey”; the time of the event, “timeStamp”, the identifier of the key or mouse button pressed during the event, “which”; the current element of the event, “currentTarget”; the reference to the object the event occurred on, “target”; a reference to the object that the mouse pointer entered, “toElement”; the title of the element, “elementTitle”; the label of an element, “elementLabel”; a custom element, “elementRevive”; a custom element “uniqueFeltId”; the width of the document where the event occurred, “documentWidth”; the width of the window where the event occurred, “windowWidth”; the zoom level of where the event occurred, “zoomLevel”; the file path to the document associated with the event, “path”, index of the item associated with the event, “itemIndex”.

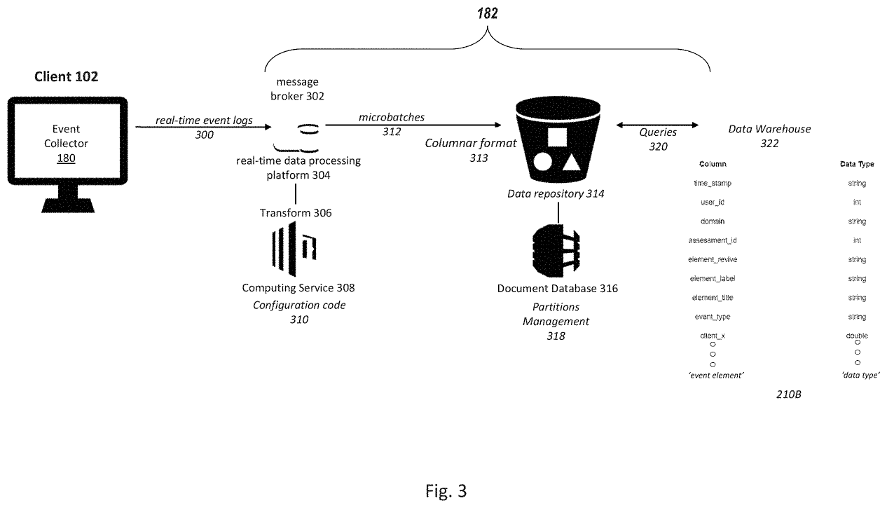

Referring now to FIG. 3, FIG. 3 illustrates a data ingestion pipeline 182 for receiving and processing client events, according to one or more disclosed embodiments. A data ingestion pipeline may be implemented using one or more cloud computing resources. FIG. 3 illustrates a non-limiting generalized data flow for a data ingestion pipeline that may be applicable to a variety of different cloud computing platforms. A person of ordinary skill in the art will understand that the principles illustrated and discussed in relation to FIG. 3 may also be implemented in other computing systems or computing devices without departure from the spirit and scope of the disclosed embodiments.

In some embodiments, the event collector 180 operates on the client 102 device. In some embodiments, the event collector 180 may be configured to send real-time event logs 300 to a message broker 302 and a real-time data processing platform 304. The real-time data processing platform 304 may include a cloud computing service sometimes known as a Kinesis Firehose. The real-time data processing platform 304 may include a service configured to automatically accept data, such as event logs 300, and send it to a specified destination, such as a data repository 314. In some embodiments, the real-time data processing platform 304 is configured to send the real-time event logs 300 to a transform 306. In some embodiments, the transform 306 may be configured to convert the real-time event logs 300, by using a configuration code 310 running on a computing service 308, to microbatches 312. In some implementations, the configuration code may include a custom code. A custom code may comprise a set of rules for processing and routing captured events in a computing environment such as a cloud computing environment. In some implementations, the computing service 308 may include a cloud computing service sometimes known as a Lambda. The Lambda may comprise an event-driven, server-less computing platform. The configuration code 310 may be configured by the user. In some implementations, the configuration code 310 is automatically generated by the real-time data processing platform 304.

In some embodiments, the message broker 302 is configured to send microbatches 312 to a data repository 314. According to some embodiments, the microbatches 312 may be stored in the Parquet Format 313 or any other columnar format. The Parquet Format defines storage of nested data structures in a flat columnar format. In some embodiments, the microbatches 312 may be scheduled on a predetermined basis such as 5 minute microbatches. The data repository 314 may include a cloud computing service sometimes known as a Data Lake. In some embodiments, the data repository 314 is configured to store the microbatches 312 in a document database 316. The document database 316 may include a cloud computing service sometimes known as a DynamoDB. In some embodiments, the document database 316 applies partitions management 318 to the microbatches 312. In some embodiments, the data repository 314 is communicatively coupled to a data warehouse 322. The data warehouse 322 may include a cloud computing service sometimes known as Hive. The data warehouse 322 may be configured to reduce programming models to a simplified representation and to support data warehouse interactions, such as querying, filtering, analysis, retrieval, extraction, transformations, or any other interactions known in the art. The data repository 314 and the data warehouse 322 may be configured to exchange queries 320. The queries 320 may include SQL or HiveQL Queries. In some embodiments, the queries 320 comprise data about an event 210B. In some embodiments, the event 210B comprises event elements associated with a data type.

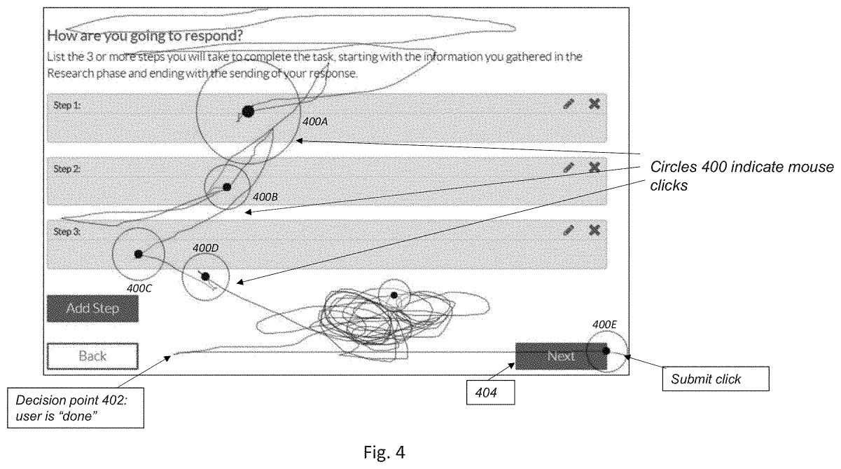

Referring now to FIG. 4, FIG. 4 illustrates a non-limiting example of a gesture or decision gesture, which represent a target segment extracted from the full trajectories of all mouse movements on a page, according to one or more disclosed embodiments. According to some embodiments, a gesture may include a plurality of events 210, or a pattern of events. A decision gesture may comprise events 210 collected between detection of a decision and an event representing submission or conclusion of a task. FIG. 4 illustrates a non-limiting example of events 210 collected from a user interface shown by a line tracking mouse movements and circles 400A-400E representing mouse clicks. One or more gestures, including a decision gesture may be extracted from the events illustrated in FIG. 4.

In some embodiments, a gesture may include a pattern of events corresponding to mouse movement ending with a mouse click. According to some embodiments, a gesture may include a pattern of events beginning with a mouse click and including events corresponding to mouse movement. According to some embodiments, a gesture may include a pattern of events corresponding to the user typing text into a text box, and may further include a mouse click event in addition to the typing events. One of ordinary skill in the art will understand that other gestures may be collected and any set of events 210 may be used in identifying gestures without departing from the spirit and scope of the disclosed embodiments.

In some embodiments, the gesture may include a decision gesture. A gesture may include a set of events, including movement of an input device, movement of a mouse, a key press, an input from a touch interface, and/or any other user interaction with an electronic device. In some embodiments, the gesture may comprise a decision point 402, which represents a point at which the user finishes interacting with the module. In FIG. 4, the decision point 402 may be identified based on an abrupt change in direction of mouse movement. In another non-limiting example, the decision point 402 may be identified based on the beginning of a mouse movement in a direct path to a submission button or next button 404 in the user interface. In some embodiments, the decision gesture includes events 210 from the decision point 402 at which the user decides they are done with the activity, to the point the point that the user clicks the Submit (Next) 404 button. In some embodiments, the decision gesture may comprise a target segment extracted from the trajectories of mouse movements on a page. The gesture may comprise mouse clicks 400A-400N (generally referred to using reference numeral 400) represented by one or more circles 400 in FIG. 4. A mouse click may be associated with an event 210. In some embodiments, a click can be a submit click 400E. One of ordinary skill in the art will understand that other criteria for identifying decision points and gestures may be used without departing from the spirit and scope of the disclosed embodiments.

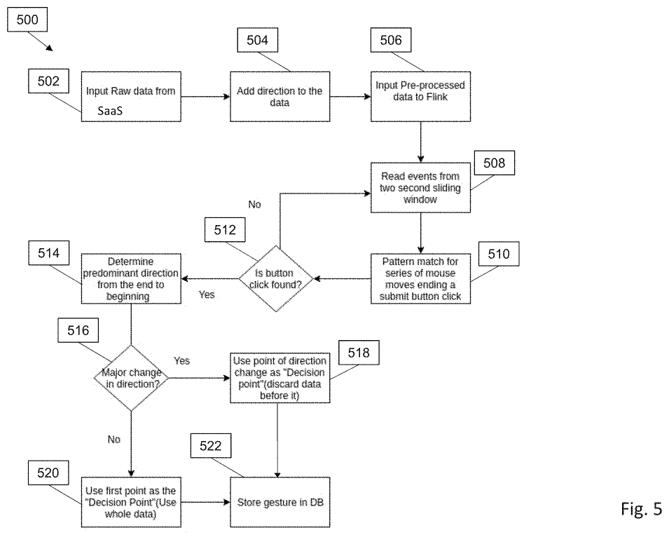

Referring now to FIG. 5, FIG. 5 illustrates a flow chart of a method of a gesture extractor 184, which outputs a pattern of events 210 for one or more gesture types, and stores the gesture to a database, according to one or more disclosed embodiments. The method 500 may include inputting raw data, including captured events 210, from a user interface (BLOCK 502). The method 500 may include adding direction to the data (BLOCK 504). According to some embodiments, captured events 210 may include a series of pixels, identified by x and y coordinates, over which the mouse traversed. Adding direction may comprise converting pixels over which the mouse traversed by finding a difference between the x and y coordinates of traversed pixels. Data processed according to BLOCK 504 may be identified as pre-processed data. According to some embodiments, pre-processed data may include other processing of raw data, such as filtering, transformation, normalization, or any other processing in preparation for identifying a pattern of events as a gesture in the captured events 210 of the raw data.

The method may further include inputting pre-processed data to a streaming dataflow engine. (BLOCK 506). According to some embodiments, the streaming dataflow engine may be implemented using a tool or service, such as Apache Flink. The method 500 may further include using the streaming dataflow engine for reading captured events 210 from a sliding window of time (BLOCK 508). According to some embodiments, the sliding window of time may comprise a two-second window. According to some embodiments, the sliding window of time may comprise one (1) second, less than one (1) second, or more than two (2) seconds. One of ordinary skill in the art will understand that other durations may be used for the sliding window of time without departing from the spirit and scope of the disclosed embodiments.

The method 500 may further include using the streaming dataflow engine to perform pattern matching for a series of mouse movement events ending with a submit button click (BLOCK 510). The method 500 may further include using the streaming dataflow engine to determine if a button click event is found (BLOCK 512). If a button click event is not found, then the method 500 will return to BLOCK 508 to read one or more additional events based on the sliding window of time. If the button click event is found, then the method 500 will transition from BLOCK 512 to BLOCK 514.

At BLOCK 514, the method 500 may further include determining a predominant direction between two captured events read from the sliding window of time (BLOCK 514). According to some embodiments the method may determine a predominant direction between an event at the end and an event at the beginning of the sliding window of time. According to some embodiments, the event at the end or beginning of the sliding window of time may include the button click event.

The method 500 may further include determining whether a major change in the direction is present in the events 210 (BLOCK 516). According to some embodiments a major change in direction may include a change in predominant direction greater than 90 degrees. According to some embodiments, a major change in direction may include a change in predominant direction greater than 100 degrees. One of ordinary skill in the art will recognize that other thresholds may be used for a major change in direction without departing from the spirit and scope of the disclosed embodiments.

According to some embodiments, the method 500 may determine whether a major change in direction is present in the events corresponding to the sliding window of time. In response to determining that a major change in direction is present, the method 500 may use the point of direction change as a decision point 402 and discard the event data before the decision point 402 (BLOCK 518) and preserve the remaining event data in the sliding window of time as a detected gesture. In response to determining that no major change in direction exists in the event data, the method 500 may proceed to BLOCK 520.

At BLOCK 520, the method may use a first event in the sliding window of time as the decision point 402 and preserve the event data in the sliding window of time as a detected gesture (BLOCK 520). The method 500 may include storing the gesture in a database (DB) (BLOCK 522). In some embodiments, the database may comprise the data warehouse 190. The method 500 can repeat the steps from blocks 502-522.

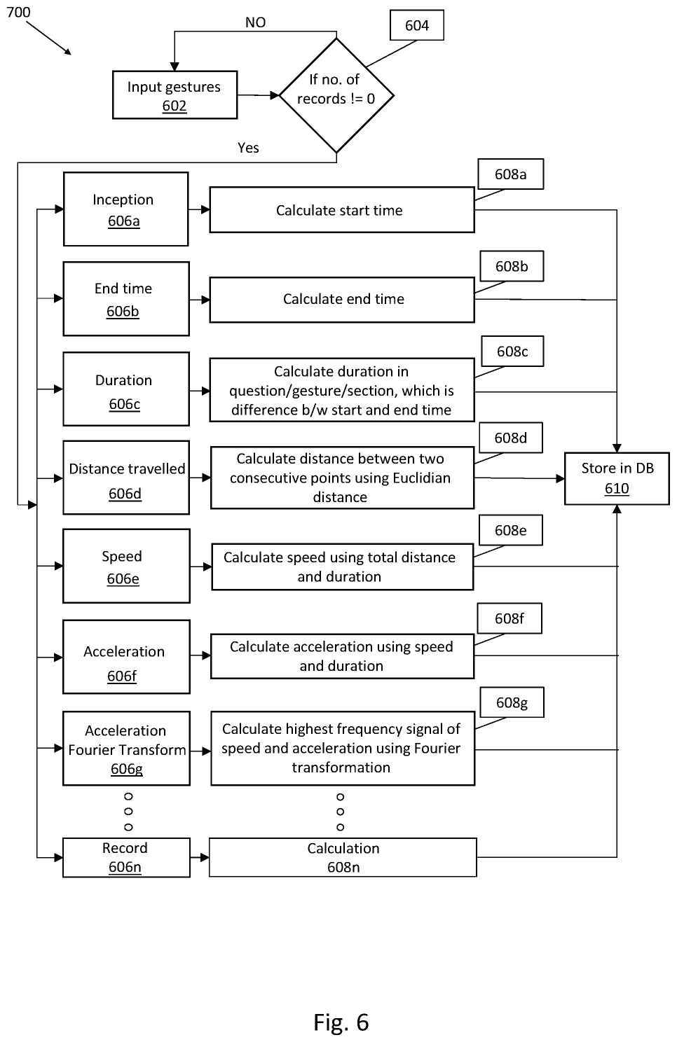

Referring now to FIG. 6, FIG. 6 illustrates a first set of machine learning (ML) features extracted from a target gesture, and used to train an affect prediction model, according to one or more disclosed embodiments. The method 600 may include inputting gestures (BLOCK 602). According to some embodiments, inputting gestures may include inputting records comprising one or more gestures detected using the gesture extractor 184 method of FIG. 5. In some embodiments, the gestures may be inputted from the data warehouse 190. The method 600 may include determining whether the number of records comprising a gesture is zero. (BLOCK 604). In response to determining that the number of records comprising one or more gestures is zero, the method 600 will transition from BLOCK 604 to BLOCK 602 to receive additional inputs. In response to determining that the number of records comprising one or more gestures is not zero, the method 600 will proceed to BLOCK 606a-606n.

At BLOCK 606a-606n, the method may generate one or more features of an input gesture (BLOCK 606a-606n). A feature may include one or more features 606a-606n (generally referred to using reference numeral 606). The generating of one or more features 606 may be performed based on a feature definition (BLOCK 608a-608n). The feature definition may include one or more calculations 608a-608n (generally referred to using reference numeral 608).

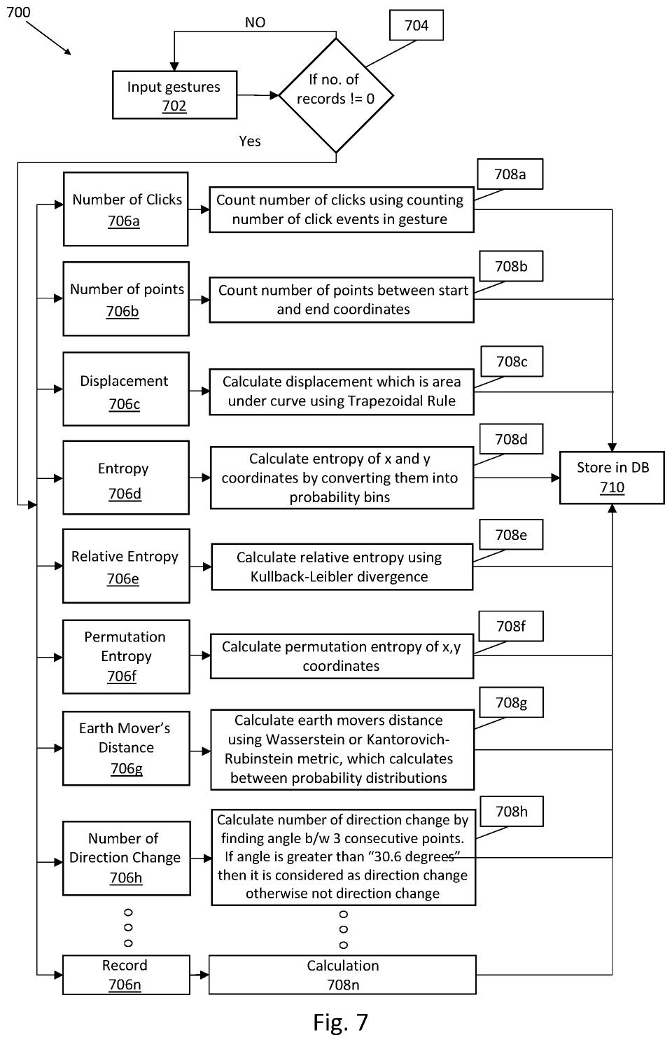

Each feature 606 generated using a calculation 608 may be stored in the DB (BLOCK 610). The method 600 may include generating an inception feature 606a by calculating a start time (BLOCK 608a). The method 600 may include generating an end time feature 606b based on calculating an end time (BLOCK 608b). The method 600 may include generating a duration feature 606c by calculating a difference between a start and an end time (BLOCK 608c). The duration feature 606c may correspond to a duration of the gesture. The method 600 may include generating a distance travelled feature 606d by calculating a distance between two points corresponding to events included in the gesture (BLOCK 608d). The calculation of distance may include using a Euclidean distance. The method 600 may include generating a speed feature 606e by calculating a speed of movement between events included in the gesture using total distance and duration (BLOCK 608e). The method 600 may include generating an acceleration feature 606f by calculating acceleration using one or more changes in speed and one or more durations corresponding to the one or more changes in speed (BLOCK 608f). The method 600 may include generating an acceleration Fourier transform feature 606g by calculating the highest frequency signal of speed and acceleration using a Fourier transformation on the acceleration and speed (BLOCK 608g). According to some embodiments, other features 606n may be generated based on other feature definitions 608n. Referring now to FIG. 7, FIG. 7 illustrates a second set of machine learning (ML) features extracted from a target gesture, and used to train an affect prediction model, according to one or more disclosed embodiments. The method 700 may include inputting gestures (BLOCK 702). According to some embodiments, inputting gestures may include inputting records comprising one or more gestures detected using the gesture extractor 184 method of FIG. 5. In some embodiments, the gestures may be inputted from the data warehouse 190. The method 700 may include determining whether a number of records comprising one or more gestures is zero. (BLOCK 704). In response to determining that the number of records comprising one or more gestures is zero, the method 700 will transition from BLOCK 704 back to BLOCK 702 to receive additional gesture inputs. In response to determining that the number of records comprising one or more gestures is not zero, the method 700 will proceed to BLOCK 706a-706n.

At BLOCK 706a-706n, the method may generate one or more features of an input gesture (BLOCK 706a-706n). A feature may include one or more features 706a-706n (generally referred to using reference numeral 706). The generating of one or more features 706 may be performed based on a feature definition (BLOCK 708a-708n). The feature definition may include one or more calculations 708a-708n (generally referred to using reference numeral 708).

Each feature generated based on a calculation 708 may be stored in the DB (BLOCK 710). The method 700 may include generating an number of clicks feature 706a by counting the number of click events in the input gesture (BLOCK 708a). The method 700 may include generating a number of points feature 706n by counting a number of points between start and end coordinates included in the input gesture (BLOCK 708b). The method 700 may include generating a displacement feature 706c by calculating displacement using events in the gesture (BLOCK 708c). According to some embodiments, displacement may include area under a curve using the Trapezoidal Rule.

The method 700 may include generating an entropy feature 706d by calculating entropy of x and y coordinates of events of the gesture (BLOCK 708d). According to some embodiments, entropy may be calculated by converting x and y coordinates into probability bins. The method 700 may include generating a relative entropy feature 706e (BLOCK 708e). According to some embodiments, generating the relative entropy feature 706e may include determining a Kullback-Leibler divergence for the entropy feature 706d.

The method 700 may include generating a permutation entropy feature 706f by calculating permutation entropy of x, y coordinates of events of the input gesture (BLOCK 708f). The method 700 may include generating an earth mover's distance feature 706g by calculating an earth mover's distance using Wasserstein metric or Kantorovich-Rubinstein metric, which define measurement of distance between probability distributions (BLOCK 708g). The method 700 may include generating a number of direction change feature by counting a number of direction changes. According to some embodiments, a direction change may be determined by finding an angle between 3 consecutive points (BLOCK 708e). In some embodiments, the angle is considered as direction change only if the angle is greater than a threshold angle of “30.6 degrees”. According to some embodiments, the threshold angle may be 20 degrees, 25 degrees, 30 degrees, or 35 degrees. One of ordinary skill in the art will recognize that other threshold angles may be used without departing from the spirit and scope of the disclosed embodiments.

Machine learning models suitable for the disclosed embodiments may include, but are not limited to Neural Networks, Linear Regression, Logistic Regression, Decision Tree, support vector machine (SVM), Naive Bayes, kNN, K-Means, Random Forest, Dimensionality Reduction Algorithms, or Gradient Boosting algorithms, and may employ learning types including but not limited to Supervised Learning, Unsupervised Learning, Reinforcement Learning, Semi-Supervised Learning, Self-Supervised Learning, Multi-Instance Learning, Inductive Learning, Deductive Inference, Transductive Learning, Multi-Task Learning, Active Learning, Online Learning, Transfer Learning, or Ensemble Learning.

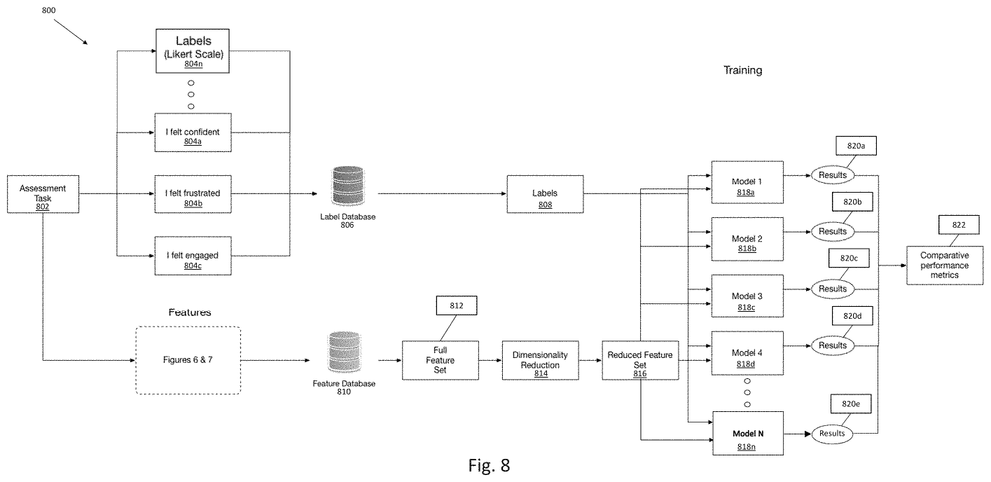

Referring now to FIG. 8, FIG. 8 illustrates a machine learning model training process of a machine learning pipeline 186, according to one or more disclosed embodiments. The method 800 may include initializing an assessment task 802. The assessment task 802 may include any task that involves user interaction with a computing device, software, or SaaS. According to some embodiments, the assessment task 802 may be configured to generate a label for training the machine learning model. A label may include one or more labels 804a-804n (generally referred to using reference numeral 804). According to some embodiments, the labels 804a-804n may be generated based on user affects. As illustrated in FIG. 8, user affect labels may include but are not limited to “I felt confident” 804a, “I felt frustrated” 804b, or “I felt engaged” 804c. Other user affects may also be used and a person of ordinary skill in the art will understand that different affect labels 804 may be used without modification to the novel features of the disclosed embodiments.

According to some embodiments, the user affects may be obtained through one or more surveys, or otherwise requesting users to report an affect. User-reported affects may be stored and used for training a machine learning model to generate user affect predictions, as described herein. In some embodiments, the labels 804n are defined according to a Likert Scale. In some embodiments, the labels 804 may be stored in a label database 806. The method 800 may transmit, by the label database 806, labels to a machine learning model for training the machine learning model. The machine learning model may include one or more machine learning models 818a-818n (generally referred to using reference numeral 818).

According to some embodiments, the assessment task 802 may be configured to send events to a gesture extractor 184 for extraction of gestures, as described in relation to FIG. 4 and FIG. 5. The system for predicting user affect may identify a set of the machine learning features extracted from the one or more gestures as described in FIG. 6 and FIG. 7. In some embodiments, the features are sent to a feature database 810. The feature database 810 may store the features. The feature database 810 may transmit a full feature set 812. The full feature set 812 may comprise one or more features.

According to some embodiments, the system may perform dimensionality reduction 814 on the full feature set 812. In some embodiments, the dimensionality reduction 814 may reduce the number of features considered by the method 800. Dimensionality reduction 814 may be performed using one or more of Principle Component Analysis (PCA) or Linear Discriminant Analysis (LDA). In some embodiments, the dimensionality reduction 814 produces a set of principal variables. In some embodiments, the dimensionality reduction 814 may divide the principal variables into feature selection and feature extraction. A person of ordinary skill in the art will understand that various methods of dimensionality reduction may be used, including PCA and LDA, without departing from the spirit and scope of the disclosed embodiments.

The dimensionality reduction 814 reduces the full feature set 812 to a reduced feature set 816. The reduced feature set 816 is transmitted to the model 818. According to some embodiments, the model 818 may combine the labels 808 and the reduced feature set 816 into a result 820. A result is associated with one or more results 820a-820n (generally referred to using reference numeral 820). According to some embodiments, the results 820 may include a user affect prediction result 820 based on the reduced feature set 816. As illustrated in FIG. 8, the machine learning model 818 may comprise a plurality of machine learning models 818a-818n. According to some embodiments, each of the one or more machine learning models 818a-818n may be trained using the same label and a different subset of the reduced feature set 816. According to some embodiments, each of the machine learning models 818a-818n may be trained using the label and a single feature of the reduced feature set.

The results 820 may be combined into comparative performance metrics 822. According to some embodiments, the comparative performance metrics 822 may comprise a loss function based on the labels 808 and the user affect prediction results 820. The loss function may perform a comparison of user affect prediction results 820 and labels 808 and return a difference between the results 820 and the labels 808. This difference may be fed back to the machine learning model 818, and used to weight or bias the machine learning model 818 or modify one or more parameters of the machine learning model to improve user affect prediction results 820. The parameters of the machine learning model are determined by the specific type of machine learning model selected for implementing the disclosed embodiments. The machine learning model may be trained using additional gestures and extracted features until an output of the loss function reaches a desired accuracy, i.e., the difference between results 820 and labels 808 is reduced to an acceptable level. Loss functions suitable for the disclosed embodiments include, but are not limited to, a hinge loss function or a multi-class support vector machine loss function, or a cross-entropy loss function.

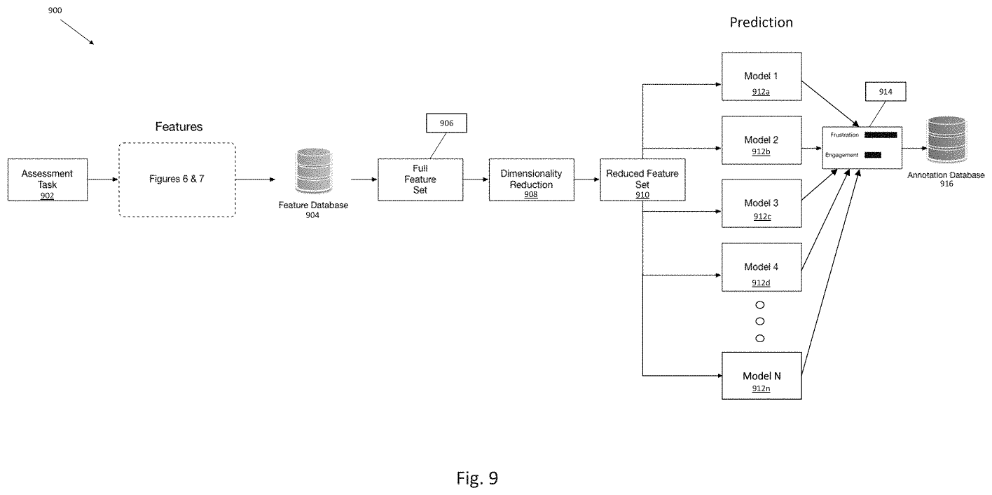

Referring now to FIG. 9, FIG. 9 illustrates the machine learning predictor or annotator of a machine learning pipeline, according to one or more disclosed embodiments. The method 900 may include initializing an assessment task 902. The assessment task 802 may include any task that involves user interaction with a computing device, software, or SaaS. The assessment task 902 may be configured to send events captured from the assessment task 902 to a gesture extractor 184 for extraction of gestures, as described in relation to FIG. 4 and FIG. 5. The method 900 may identify a set of machine learning features extracted from the one or more gestures as described in FIGS. 6 and 7. According to some embodiments, the features may be sent to a feature database 904. In some embodiments, the feature database 904 stores the features. The feature database 810 may transmit a full feature set 906 for dimensionality reduction 908.

In some embodiments, in order to limit computational cost when the system gets deployed to production at scale, extracted features may be limited to features which contribute to the performance of the model, such as but not limited to inception, number of clicks, acceleration, acceleration Fast Fourier Transform, and earth mover's distance. The full feature set 906 may comprise one or more features. In some embodiments, the system receives pre-determined features as needed to generate user affect predictions. The full feature set 916 may undergo dimensionality reduction 908. According to some embodiments, dimensionality reduction 908 may be performed according to any method of dimensionality reduction described in relation to FIG. 8. In some embodiments, the dimensionality reduction 908 may reduce the number of features considered by the method 900. In some embodiments, the dimensionality reduction 908 obtains a set of principal variables. In some embodiments, the dimensionality reduction 908 divides the principal variables into feature selection and feature extraction. The dimensionality reduction 908 reduces the full feature set 906 to a reduced feature set 910.

The reduced feature set 910 may be transmitted to the trained machine learning model. The trained machine learning model may comprise one or more models 912a-912n (generally referred to using reference numeral 912). The trained machine learning model may be trained according to FIG. 8 and the related description. The trained machine learning model 912 produces an output 914 based on the reduced feature set 910. The output 914 may include one or more user affect predictions, including information such as frustration and engagement levels. The output 914 may be transmitted to an annotation database 916. The annotation database may store the output 914. Thus, the trained machine learning model 912 may generate user affect predictions based on events captured during the assessment task 902, without requiring users of the assessment task 902 to respond to a survey or otherwise explicitly report an affect. The user affect predictions are generated based on the machine learning model 912 learning relationships between extracted features and the labels.

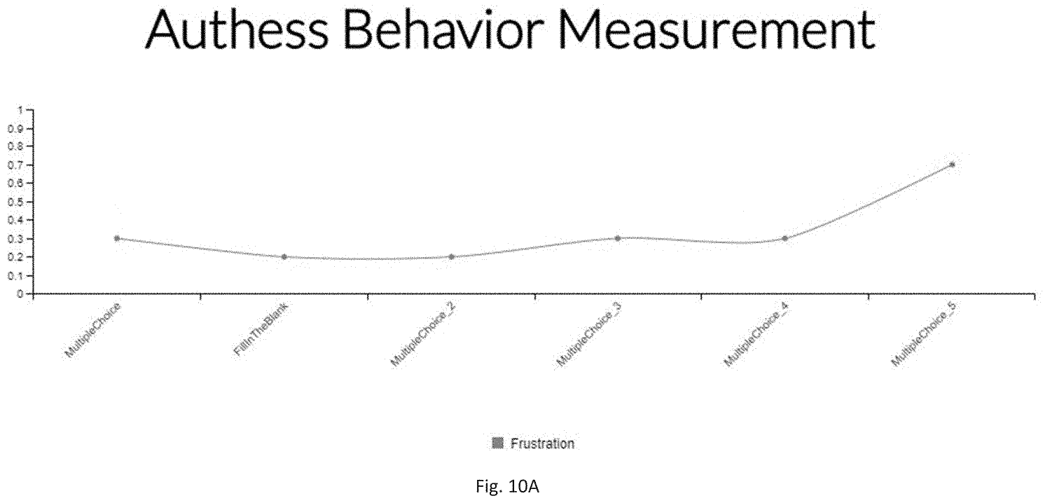

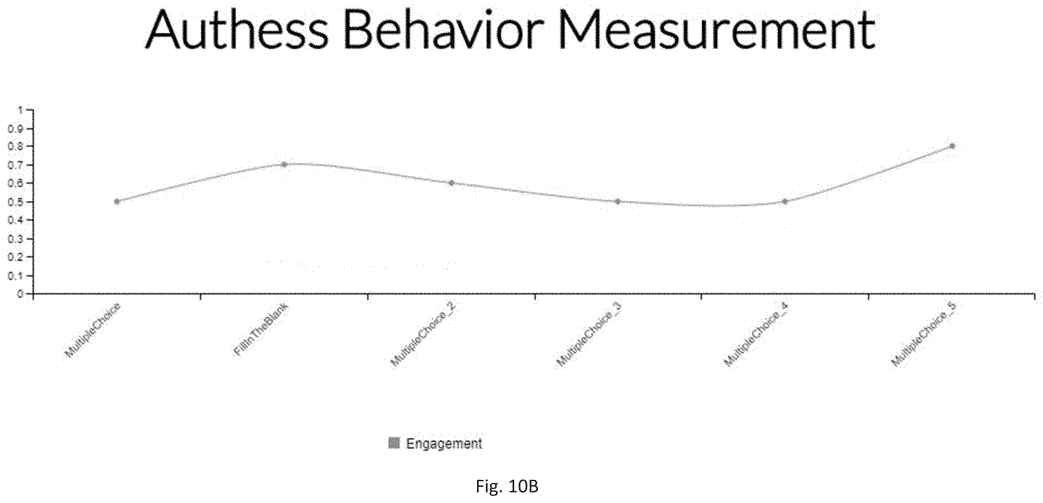

Referring now to FIG. 10A, FIG. 10A illustrates a sample frustration report showing the affect predictions for a user across all webpages on a website, according to one or more disclosed embodiments (in this non-limiting example the website is an online assessment). FIG. 10A illustrates measurement of a frustration level. The y-axis represents the frustration level and the x-axis represents various stages of a user's interaction with software or SaaS of a client 102. The client 102 may represent an assessment website, a specific page on a web application, or an assessment in which each page is a question. The affect prediction, which in this case is a frustration level, is generated for the client 102 based on a subset of the events 210 extracted by the event collector 180. The events 210 are used to build the feature set for the machine learning predictor or annotator to make a user affect prediction.

Referring now to FIG. 10B, FIG. 10B illustrates a sample engagement report showing the affect predictions for a user across all webpages on a website all webpages on a website, according to one or more disclosed embodiments (in this non-limiting example the website is an online assessment). FIG. 10B illustrates measurement of an engagement level. The y-axis represents the engagement level and the x-axis represents various stages of a user's interaction with software or SaaS of a client 102. The client 102 may represent an assessment website, a specific page on a web application, or an assessment in which each page is a question. The affect prediction, which in this case is a frustration level, is generated for the client 102 based on a subset of the events 210 extracted by the event collector 180. The events 210 are used to build the feature set for the machine learning predictor or annotator to make a user affect prediction. In some embodiments of the present disclosure, the systems and methods may provide page-by-page measurement of a user's frustration and engagement in order to improve website or software usability. The measurements may provide cohort level affect predictions of segmented users. In some embodiments of the present disclosure, the systems and methods may provide frustration and engagement as inputs to other ML models. For example, other ML models may improve scoring in open response or essay assessments. In some embodiments, the assessment may be online or over a network.

While the present solution has been particularly shown and described with reference to specific embodiments, it should be understood by those skilled in the art that various changes in form and detail may be made therein without departing from the spirit and scope of the embodiments described in this disclosure.

What is claimed is:

1. A method of generating a user affect prediction, the method comprising:
receiving one or more events generated from a user interface;
identifying a pattern, among the received events, as a gesture;
extracting one or more features of the gesture; and
generating a user affect prediction, based on the extracted features, using a trained machine learning model.

2. The method of claim 1, further comprising:
training a machine learning model to generate the user affect prediction based on the one or more events generated from the user interface.

3. The method of claim 2, wherein the training of the machine learning model comprises:
receiving a label for a user-reported affect corresponding to interactions with the user interface;
receiving, as training events, events corresponding to the interactions with the user interface;
identifying one or more patterns, among the training events, as one or more training gestures;
extracting, as one or more training features, one or more features of the training gestures;
providing the training features and the label to a machine learning model;
using the machine learning model to generate a training prediction based on the training features, wherein the generated training prediction represents a predicted user affect corresponding to the interactions with the user interface; and
generating the trained machine learning model by modifying one or more parameters of the machine learning model using a difference between the label and the training prediction.

4. The method of claim 3, wherein the one or more gestures comprise a decision gesture comprising events collected between a decision point, comprising a change in direction, and a submit click.

5. The method of claim 1, wherein the extracting of one or more features comprises performing one or more calculations of one or more feature definitions corresponding to the one or more features.

6. The method of claim 1, wherein the one or more features comprise an inception feature, a number of clicks feature, an acceleration feature, an acceleration fast Fourier transform feature, and an earth mover's distance feature.

7. The method of claim 1, wherein the events comprise one or more of a mouse movement, a mouse click, or a keypress.

8. A non-transitory computer-readable medium storing instructions that, when executed by a processor, cause the processor to perform the steps of:
receiving one or more events generated from a user interface;
identifying a pattern, among the received events, as a gesture;
extracting one or more features of the gesture; and
generating a user affect prediction, based on the extracted features, using a trained machine learning model.

9. The non-transitory computer-readable medium of claim 8, further storing instructions that, when executed by a processor, cause the processor to further perform the steps of:
training a machine learning model to generate the user affect prediction based on the one or more events generated from the user interface.

10. The non-transitory computer-readable medium of claim 9, wherein the training of the machine learning model comprises:
receiving a label for a user-reported affect corresponding to interactions with the user interface;
receiving, as training events, events corresponding to the interactions with the user interface;
identifying one or more patterns, among the training events, as one or more training gestures;
extracting, as one or more training features, one or more features of the training gestures;
providing the training features and the label to a machine learning model;
using the machine learning model to generate a training prediction based on the training features, wherein the generated training prediction represents a predicted user affect corresponding to the interactions with the user interface; and
generating the trained machine learning model by modifying one or more parameters of the machine learning model using a difference between the label and the training prediction.

11. The non-transitory computer-readable medium of claim 10, wherein the one or more gestures comprise a decision gesture comprising events collected between a decision point, comprising a change in direction, and a submit click.

12. The non-transitory computer-readable medium of claim 8, wherein the extracting of one or more features comprises performing one or more calculations of one or more feature definitions corresponding to the one or more features.

13. The non-transitory computer-readable medium of claim 8, wherein the one or more features comprise an inception feature, a number of clicks feature, an acceleration feature, an acceleration fast Fourier transform feature, and an earth mover's distance feature.

14. The non-transitory computer-readable medium of claim 8, wherein the events comprise one or more of a mouse movement, a mouse click, or a keypress.

15. A system for generating a user affect prediction, the system comprising:
a processor;
a main memory unit storing instructions that, when executed by the processor, cause the processor to perform the steps of:
receiving one or more events generated from a user interface;
identifying a pattern, among the received events, as a gesture;
extracting one or more features of the gesture; and
generating a user affect prediction, based on the extracted features, using a trained machine learning model.

16. The system of claim 15, wherein the main memory unit further stores instructions that, when executed by the processor, cause the processor to perform the steps of:
training a machine learning model to generate the user affect prediction based on the one or more events generated from the user interface.

17. The system of claim 16, wherein the training of the machine learning model comprises:
receiving a label for a user-reported affect corresponding to interactions with the user interface;
receiving, as training events, events corresponding to the interactions with the user interface;
identifying one or more patterns, among the training events, as one or more training gestures;
extracting, as one or more training features, one or more features of the training gestures;
providing the training features and the label to a machine learning model;
using the machine learning model to generate a training prediction based on the training features, wherein the generated training prediction represents a predicted user affect corresponding to the interactions with the user interface; and
generating the trained machine learning model by modifying one or more parameters of the machine learning model using a difference between the label and the training prediction.

18. The System of claim 17, wherein the one or more gestures comprise a decision gesture comprising events collected between a decision point, comprising a change in direction, and a submit click.

19. The system of claim 15, wherein the extracting of one or more features comprises performing one or more calculations of one or more feature definitions corresponding to the one or more features.

20. The system of claim 15, wherein the one or more features comprise an inception feature, a number of clicks feature, an acceleration feature, an acceleration fast Fourier transform feature, and an earth mover's distance feature.
